(19) United States
(12) Patent Application Publication
(10) Pub. No.: US 2026/0368430 A1
(43) Pub. Date: Nov. 19, 2026

(54) AUTOMATED INTENT CAPTURE AND EXECUTION

(71) Applicant: Eric Scott DeSio, Carlsbad, CA (US)

(72) Inventor: Eric Scott DeSio, Carlsbad, CA (US)

(21) Appl. No.: 19/675,868

(22) Filed: May 13, 2026

Related U.S. Application Data
(60) Provisional application No. 63/806,534, filed on May 15, 2025.
(60) Provisional application No. 63/806,761, filed on May 16, 2025.
(60) Provisional application No. 63/816,536, filed on Jun. 2, 2025.
(60) Provisional application No. 63/925,481, filed on Nov. 26, 2025.
(60) Provisional application No. 63/927,542, filed on Nov. 29, 2025.

(51) Int. Cl. G06F 40/279; G06F 40/205

(52) U.S. Cl. CPC G06F 40/279; G06F 40/205

(57) ABSTRACT

A system may receive information associated with a user from a user device, wherein the information comprises an intent and a condition that when satisfied will cause execution of an action. A system may identify, from the information, the intent. A system may generate a first-class intent object comprising the intent, the condition, and the action.

### BACKGROUND

This application claims priority under 35 U.S.C. § 119(e) to U.S. Provisional Application No. 63/806,534, filed on May 15, 2025, and titled “BUMP BET,” U.S. Provisional Application No. 63/806,761, filed on May 16, 2025, and titled “BUMP NDA,” U.S. Provisional Application No. 63/816,536, filed on Jun. 2, 2025, and titled “BUMP GOLF—PEER TO PEER GOLF BETTING,” U.S. Provisional Application No. 63/925,481, filed on Nov. 26, 2025, and titled “SYSTEMS AND METHODS FOR PEER-GENERATED REAL-TIME PREDICTIONS—PEERDICTIONS,” and U.S. Provisional Application No. 63/927,542, filed on Nov. 29, 2025, and titled “SYSTEMS AND METHODS FOR PREDICTION-TRIGGERED PAYMENTS AND CONDITIONAL MICRO-SUPPORT,” the contents each of which are hereby incorporated by reference in their entireties and for all purposes.

### BACKGROUND

Computer systems can receive user input that explicitly defines a request to purchase an item, or take another action, if a user-defined condition in the user input is met. User input may be provided through a user interface presented through a display of a user device. Systems may use the received input to initiate processing, store transaction-related data, or trigger downstream operations.

### SUMMARY

In some aspects, the techniques described herein relate to a computer-implemented method including: receiving information associated with a user from a user device, wherein the information includes an intent and a condition that when satisfied will cause execution of an action; identifying, from the information, the intent; generating a first-class intent object including the intent, the condition, and the action; and storing the first-class intent object in computer-readable memory, wherein the computer-implemented method is performed by a computer system.

The computer-implemented method of the preceding paragraph may include any sub-combination of the following features: wherein storing the first-class intent object causes the first-class intent object to become available to at least one third party; wherein identifying the intent comprises parsing the information to isolate a portion of the information, and analyzing the portion of the information to determine the intent; receiving condition information, comparing the condition information to the condition to determine whether the condition is satisfied, and based on determining that the condition is satisfied, causing execution of the action; wherein causing execution of the action comprises transmitting a request to a third party system to cause the third party system to execute the action; wherein causing execution of the action comprises transmitting a notification to the user device indicating the condition is satisfied; wherein causing execution of the action comprises transmitting an instruction to the user device to cause the user device to execute the action; wherein the first-class intent object comprises evaluation logic, and wherein comparing the condition information to the condition comprises executing the evaluation logic; wherein the first-class intent object comprises a lifecycle state, and wherein the computer-implemented method further comprises updating the lifecycle state to generate an updated first-class intent object and storing the updated first-class intent object; wherein the information comprises text information; wherein identifying the intent comprises applying the information as input to a machine learning model trained to generate intent information to cause the machine learning model to generate the intent.

In some aspects, the techniques described herein relate to a computer-implemented method including: receiving information associated with a user from a user device, wherein the information includes an intent and a condition that when satisfied will cause execution of an action; identifying, from the information, the intent; generating an intent object including the intent, the condition, and the action, wherein the condition includes evaluation logic defining how a computing system is to determine whether the condition is satisfied, wherein the action includes an indication of an action object associated with the intent object, and wherein the action object includes execution logic for executing the action; and storing the intent object in a data store, wherein the stored intent object is available to two or more third party computing systems based on an access permission associated with the intent object, wherein the computer-implemented method is performed by a computer system.

The computer-implemented method of the preceding paragraph may include any sub-combination of the following features: receiving condition information comprising an indication of a change in status associated with the condition, executing the evaluation logic based at least in part on the condition information to determine whether the condition has been satisfied, based on determining the condition has been satisfied, accessing the action object to identify the execution logic for executing the action, and executing the action based on the identified execution logic; updating, based on executing the action, the intent object to generate an updated intent object, and causing the updated intent object to replace the stored intent object; wherein the action is associated with a first service provider, wherein the first service provider is associated with a first third party computing system of the two or more third party computing systems, and wherein the computer-implemented method further comprises following the updated intent object replacing the stored intent object, receiving second condition information, executing the evaluation logic of the updated intent object based at least in part on the second condition information to determine whether a second condition associated with a second action executable by a second service provider has been satisfied, wherein the second service provider is associated with a second third party computing system of the two or more third party computing systems different from the first third party computing system, and based on the second condition being satisfied, instructing the second service provider to execute the second action; wherein identifying the intent comprises applying the information as input to a machine learning model trained to generate intent information to cause the machine learning model to generate the intent; wherein the intent object comprises a plurality of conditions associated with a plurality of actions, wherein a first portion of the plurality of actions is associated with a first service provider, and wherein a second portion of the plurality of actions is associated with a second service provider different from the first service provider; wherein the evaluation logic comprises at least one of: an equation, or a natural language description of an evaluation process; a non-transitory computer-readable storage comprising instructions stored thereon that, when executed by a computing system, cause the computer-implemented method to be performed.

In some aspects, the techniques described herein relate to a computer system including: computer-readable storage storing instructions; and one or more processors configured to execute the instructions to at least: receive information associated with a user from a user device, wherein the information includes an intent and a condition that when satisfied will cause execution of an action; identify, from the information, the intent; generate an intent object including the intent, the condition, and the action, wherein the condition includes evaluation logic defining how a computing system is to determine whether the condition is satisfied, wherein the action includes an indication of an action object associated with the intent object, and wherein the action object includes execution logic for executing the action; and store the intent object in a data store, wherein the stored intent object is available to two or more third party computing systems based on an access permission associated with the intent object.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 is a block diagram of an illustrative environment for generating intent objects and causing execution of actions according to some embodiments.

FIG. 2 is a flow diagram of an illustrative routine for generating an intent object according to some embodiments.

FIG. 3 is a flow diagram of an illustrative routine for executing an action based on a stored intent object according to some embodiments.

FIG. 4 is a block diagram of an illustrative computing system configured to provide intent object generation and execution according to some embodiments.

### DETAILED DESCRIPTION

The following description of certain embodiments presents various descriptions of specific embodiments. However, the innovations described herein may be embodied in a multitude of different ways, for example, as defined and covered by the claims. In this description, reference is made to the drawings where like reference numerals may indicate identical or functionally similar elements. It will be understood that elements illustrated in the figures are not necessarily drawn to scale. Moreover, it will be understood that certain embodiments may include more elements than illustrated in a drawing and/or a subset of the elements illustrated in a drawing. Further, some embodiments may incorporate any suitable combination of features from two or more drawings. Any suitable principles and advantages of the embodiments disclosed herein may be implemented together with each other. The headings provided herein are for convenience only and do not necessarily affect the scope or meaning of the claims.

The present disclosure relates to the generation of a durable first-class object representing human intent. Intent can refer to a human-originated desired outcome, preference, or conditional willingness to act, expressed explicitly or implicitly. Information received from a user or a third party system may be used to generate an intent object that is decoupled from an originating environment to allow for use and/or reuse of the intent object by various computing systems.

Some existing systems, such as those operated by service providers, receive user-generated input, including user declarations or requests to perform an action in response to a condition. Such input may be provided by a user through various interface types (e.g., financial forms, contract templates, payment sites, etc.) to a computing system so that the computing system can execute an action based on the user input at a later time. However, such systems are limited in that the user's input, which may represent an intent of the user, is local to the system that received the user input. Therefore, even if a user's intent is relevant to multiple systems, the user will have to explicitly provide their intent to each distinct system individually.

Further, such systems store the user input until an action is triggered, and then consume and erase the user input or otherwise render the user input into a form where it is no longer analyzed. Therefore, once an action has been triggered based on the user input, the user input is not reusable by the system. This consumption of the user input may result in significant inefficiencies in existing computing systems by relying on a user to re-enter input after an action has been executed. Consuming the user input in this way, and relying on the user to re-enter input, may result in a failure to execute a repeatable action every time a condition is met or inefficient duplication of user input so that one object including the user input is stored for each expected execution of an action. Additionally, by consuming the user input when executing an action, such systems provide reduced traceability for actions that are taken by the system, leading to significant time and computing resources being used to determine why an action was taken or whether the action was intended.

Some aspects of the present disclosure address some or all of the issues noted above, among others, by providing an intent generation system that receives user information and generates a durable first-class object, referred to as an intent object, to store information associated with the user's intent. For example, the intent object may include intent information, a condition for executing an action based on the intent, an action that may be executed based on the condition, and other information useful for executing an action that satisfies the user intent. Additionally, the intent generation system of the present disclosure may generate an intent object without the user providing an explicit intent declaration. For example, the intent generation system may analyze received user information to determine whether an intent is present, implicitly or explicitly, and then generate an intent object when an intent is identified. Advantageously, the intent generation system does not require the user to explicitly indicate their intent, and allows for the generation of intent objects without the use of specialized user interfaces for capturing intent information that are used by some existing systems.

Further, the intent object generated by the system of the present disclosure is durable and may be provided to two or more service providers (or third party systems) to allow those service providers (or third party systems) to take action when a condition of the intent is satisfied. The intent object is durable, as the intent object may not be consumed or deleted when an action is taken based on the intent object. Such durability provides users, the system provider, or third party service providers to audit the intent object and determine why an action was taken, whether the action was correctly executed based on the user's intent, and otherwise audit the execution of actions based on intents. Durability of the intent object advantageously allows a first service provider to act on an intent object without affecting the ability of a second service provider to act on the same intent object even after the first service provider has executed an action based on the intent object.

Various aspects of the disclosure will be described with regard to certain examples and embodiments, which are intended to illustrate but not limit the disclosure. Although aspects of some embodiments described in the disclosure will focus, for the purpose of illustration, on particular examples of intents, execution conditions, and the like, the examples are illustrative only and are not intended to be limiting. In some embodiments, the techniques described herein may be applied to additional or alternative types of intents, execution conditions, and the like. Additionally, any feature used in any embodiment described herein may be used in any combination with any other feature or in any other embodiment, without limitation.

### Example Intent Object Generation and Action Execution Environment

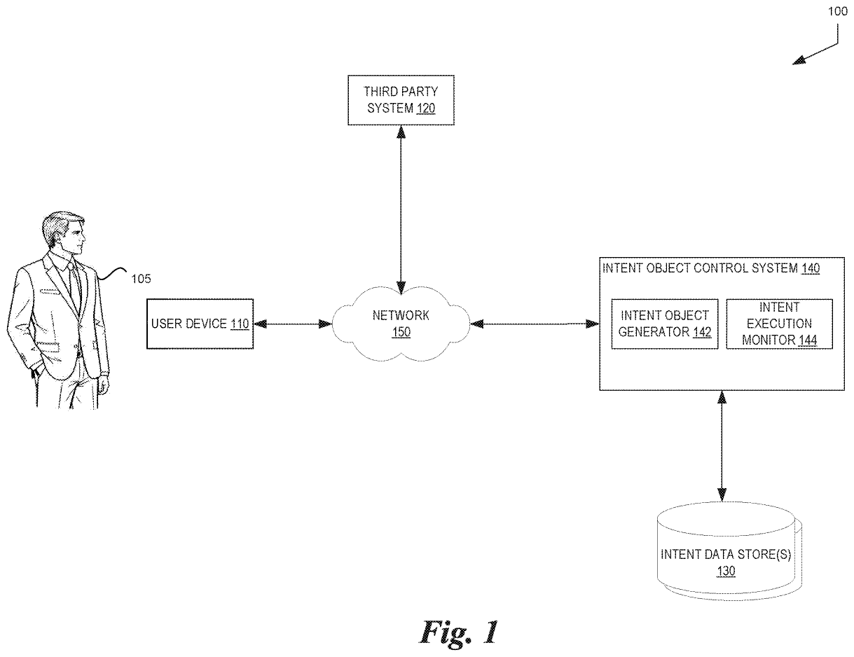

With reference to an illustrative example, FIG. 1 shows an example environment 100 for providing storage and use of a human intent as a first-class object. The first-class object can refer to an explicit, persistent system object representing intent with its own identity and lifecycle, independent of execution attempts. The environment 100 of this example includes a user 105, a user device 110, a third party system 120, an intent object control system 140, intent object data store(s) 130, and a network 150.

The user device 110 may be a computing device associated with a user 105, for example, a user 105 that may provide information used by the intent object control system 140 to generate an intent object stored as a first-class object (e.g., in the intent object data store(s) 130), or information used by the intent object control system 140 to determine whether an execution condition associated with a stored intent has occurred. The user device 110 may include one or more inputs (e.g., a keyboard, a camera, a microphone, etc.). The user device 110 may include one or more outputs (e.g., a speaker, a display, etc.). In some embodiments, the user device 110 may provide computing resources to execute at least a portion of an action or routine described herein. The user device 110 may capture information used by the intent object control system 140 through a specified application (e.g., an intent capture application, a third party application in communication with the intent object control system 140, a system-level process, etc.).

The third party system 120 is a computing system that may be used to execute at least a portion of an action based on an execution condition associated with an intent object. The third party system 120 may be under the control of a service provider that provides a service for a user 105. The intent object control system 140 may communicate with the third party system 120 (e.g., via the network 150) to cause execution of an action by the third party system 120. The third party system 120 may provide confirmation to the user device 110 and/or the intent object control system 140 when an action has been executed. The third party system 120 may provide information to the intent object control system 140 associated with conditions that may cause execution of an intent based on an intent object stored by the intent object control system 140 (e.g., in the intent object data store(s) 130). The third party system 120 may access or view an intent object provided by the intent object control system 140. Based on a governance policy or permission associated with the accessed intent object, the third party system 120 may have limited, or no, ability to execute an action based on the intent object.

The intent object control system 140 receives intent-related information (e.g., from a user device 110) that is associated with a user 105 to generate and store an intent object (e.g., in the intent object data store(s) 130), and may execute an action based on an execution condition associated with the stored intent object. The intent object control system 140 of this example includes an intent object generator 142 and an intent execution monitor 144.

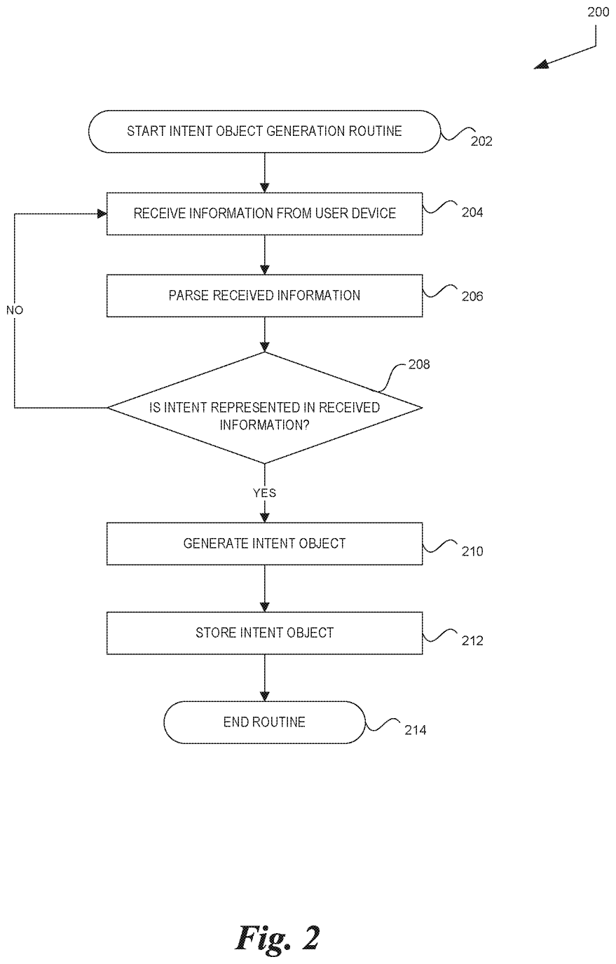

The intent object generator 142 generates intent objects to be stored and used as a first-class object representation of a human intent. Intent objects generated by the intent object generator 142 may include, for example, a unique identifier, a lifecycle state, an indication of a governance policy, a condition, a description of an action to be executed when the condition is satisfied, a description of an action to be executed if the condition is not satisfied (e.g., within a threshold time window), additional metadata, or any other information useful for representing an intent, condition, or action. The generation and structure of an intent object generated by the intent object generator 142 is discussed in further detail below with respect to FIG. 2.

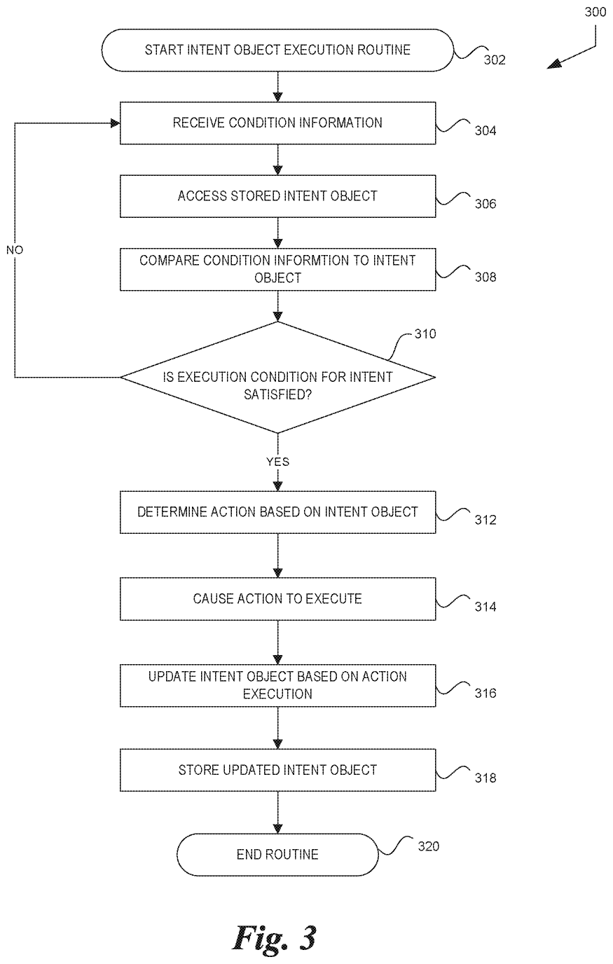

The intent execution monitor 144 receives information associated with the execution of an intent (e.g., from a user 105, user device 110, or third party system 120) and, when a condition associated with an intent object is satisfied or not satisfied (e.g., within a threshold time), causes execution of an action. Evaluation of a condition by the intent execution monitor 144, and execution of an action, is discussed in further detail below with respect to FIG. 3.

The intent object data store(s) 130 is a storage location accessible to the intent object control system 140 and used to store generated intent objects. The intent object data store(s) 130 may be accessible to additional systems (e.g., a third party system 120 or user device 110), or may restrict access to the intent object control system 140. In some embodiments, the intent object data store(s) 130 may encrypt or otherwise secure stored intent objects. The intent object data store(s) 130 may provide access to specific stored intent objects based on an identifier of the intent object, user identifier of the intent object, or based on other information included in, or associated with, the intent object.

The network 150 may be a publicly-accessible network of linked networks, some or all of which may be operated by various distinct parties, for example the Internet. In some cases, network 150 may include a private network, personal area network, local area network, wide area network, cellular data network, satellite network, etc., or some combination thereof. In some cases, the network 150 may be or may include the Internet.

### Example Intent Object Generation and Action Execution Routines

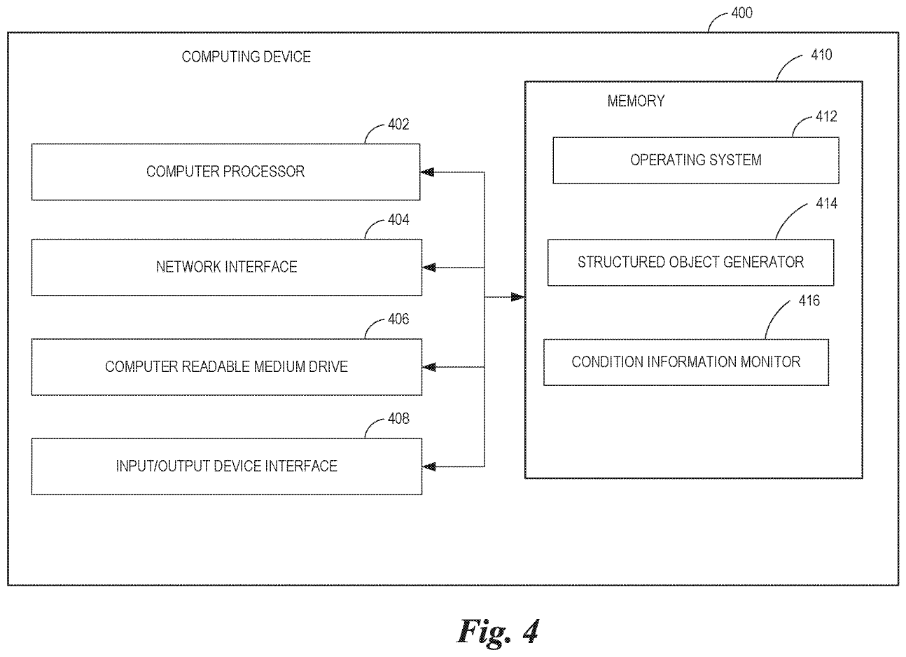

When a routine described herein (e.g., routine 200 or routine 300) is initiated, a set of executable program instructions stored on one or more non-transitory computer-readable media (e.g., hard drive, flash memory, removable media, etc.) may be loaded into memory (e.g., random access memory or RAM) of a computing device, such as the computing device 400 shown in FIG. 4, and executed by one or more processors. In some embodiments, the routines 200, 300, or portions thereof, may be implemented on multiple processors, serially or in parallel.

Routines described herein may refer, in part, to an order of operations, blocks, or steps. It should be understood that any reference to an order of the blocks of a routine is intended to aid in the explanation of the routine only, and does not imply that such an order is required for performing the operation described by the routine. Blocks of the routines described herein, therefore, should be understood to be capable of being performed before, after, and/or simultaneously with any other block of the routine as appropriate. Additionally, various blocks of routines described herein may be performed repeatedly even where no loop is explicitly shown. Such loops may be excluded from the description of a routine for the purpose of clarity, and does not require that a block be performed only once before the routine proceeds. Further, some blocks shown in a routine herein may be optional, and therefore may be excluded in some implementations.

FIG. 2 illustrates an example routine 200 for generating an intent object. The routine 200 begins at block 202, for example in response to receiving a connection request from a user device 110 associated with a user 105.

At block 204, the intent object control system 140 receives information from the user device 110. The information may be visual information (e.g., image or video information), audio information (e.g., representing speech of the user 105), text information (e.g., input by a user 105 of the user device 110 via a keyboard, or otherwise provided to the user device 110), contextual information, or multimodal information including information of two or more types (e.g., video information and associated audio information, text information and audio information from which the text information was generated, etc.).

The information received by the intent object control system 140 may include an explicit declaration of an intent. For example, audio information received from a user may include a recitation that states “I bet that the weather will be sunny tomorrow.” In this example, the statement “I bet” serves as the explicit declaration that an intent is included in the audio information, and indicates the intent is to bet that the weather will be sunny “tomorrow” based on the additional audio information.

The intent object control system 140 may receive information including an implicit declaration of an intent. For example, text information received by the intent object control system 140 from the user device 110 may include a recitation that “If I knew this device would be fully funded, I would buy one too.” As will be described in further detail below, such a statement includes an implicit declaration of intent that may be associated with the user and used to generate an intent object by the intent object generator 142. The information received by the intent object control system 140 may include contextual information and the intent object control system 140 may use the contextual information as part of generating an intent object as described below. Contextual information may include, for example, a device location, a time, device identifier, user identifier, or any other information received by the intent object control system 140.

While the above description discusses information being received from a user device 110, in some embodiments the intent object control system 140 may receive information from a third party system 120 used to generate at least a portion of an intent object.

At block 206, the intent object generator 142 parses the received information. Parsing the received information by the intent object generator 142 may include identifying portions of information received by the intent object control system 140 that may represent an intent that is present in the received information, an action, or a condition, relevant to the generation of an intent object by the intent object generator 142. The intent object generator 142 may use a rules-based system to parse the information. The intent object generator 142 may apply the set of rules to identify portions of the received information relevant to determination of whether an intent is present, or to identify information that may be relevant to generating an intent object. For example, the intent object generator 142 may apply a set of rules to identify terms or phrases that suggest an implicit or explicit intent (e.g., “I bet,” “I intend to,” “I would,” “I will . . . if,” “I'm in,” etc.). The intent may be associated with a condition. The intent object generator 142 may apply a set of rules to identify a condition present in received information (e.g., “If funding for this widget reaches $10,000,” “When I get to work tomorrow,” etc.). Where a portion of the information is determined to be an intent, the intent object generator 142 may generate metadata or a label indicating the portion of the information including the intent. Further, where a portion of the information is determined to be a condition, the intent object generator 142 may generate metadata or a label indicating the portion of the information including the condition.

While the previous examples represent a one-to-one mapping of an intent to a condition, it should be understood that any suitable number of intents and/or conditions may be associated with each other. Further, conditions can include one or more steps or elements that, when satisfied in part or as a whole, satisfy the condition. For example, multiple conditions may be associated with a single intent in the phrase “If I have money left over tomorrow, and I am back at this store, I will buy this jacket.” In this example, the conditions are having money left over “tomorrow” and the user 105 returning to the same store, and the intent is to buy the jacket. Additionally, where an intent object comprises two or more conditions the conditions may be related. Related conditions may include conditions that are mutually exclusive, or conditionally associated. Mutually exclusive conditions may include conditions where when a first condition of the two or more conditions is satisfied, a second condition will be rendered inactive (e.g., by adjusting a lifecycle state of the intent object). Mutually exclusive conditions may result in a first-to-complete scenario where satisfaction of a first condition causes execution of an action of the intent object, rendering a second condition moot. Conditionally associated conditions may be represented as a chain of conditions, where satisfaction of a first condition in the chain of conditions is a prerequisite for satisfaction of a second condition in the chain of conditions.

The intent object generator 142 may implement a machine learning model to identify an intent or condition. The machine learning model may be trained to determine whether information received from the user device 110 by the intent object control system 140 includes one or more intents or conditions associated with an intent. The machine learning model may receive information from the user device 110, and based on the information generate an output including a description of an intent and/or a condition. In some embodiments, the intent object generator 142 may implement a plurality of machine learning models. For example, the intent object generator 142 may use a first machine learning model for information of a first type (e.g., audio information) and a second machine learning model for information of a second type (e.g., text information).

The intent object generator 142 may identify an action to be executed on satisfaction of the condition, where the action is associated with the intent. For example, in the phrase “I want to buy that computer when it goes on sale,” the intent is to buy the computer, the condition is when the computer goes on sale, and the action is to cause purchase of the computer to satisfy the user's intent when the condition is met. The action may be directly part of the intent (e.g., when the user's intent is to buy an item, the action may be to buy that item for the user), or may be distinct from the intent.

The intent object generator 142 may isolate portions within a fixed or variable window around an identified term or phrase during parsing. The window may be a time-based window (e.g., 3 seconds, 10 seconds, 40 seconds, etc.), a number of words (e.g., within 5 words, 15 words, etc.), a number of sentences (e.g., within 1 sentence, 3 sentences, etc.), or any other type of value that may be used to determine a portion of information relevant to an intent. For example, audio information may include a statement by the user that “If I could just find my wallet, I would use my credit card to buy that toy.” In this example, the intent is to “buy that toy,” and the intent object generator 142 may use a window that includes the entire sentence when determining that the condition is the user 105 finding their wallet.

At decision block 208, the intent object generator 142 determines whether an intent is present in the received information. The intent object generator 142 may determine whether the intent is present based on metadata or a label applied by the intent object generator 142 to the parsed information. In some embodiments, the routine 200 may omit the step of parsing the information and the intent object generator 142 may determine whether the intent is present based on a keyword analysis applied to the information to identify words or phrases associated with an intent, or use a machine learning model trained to identify an intent in received information. Where an intent is determined to be present in the information, the routine 200 moves to block 210 and continues. Where an intent is determined not to be present in the information, the routine 200 returns to block 204 and continues to receive information from the user device 110. In some embodiments, an intent or condition may be identified in a first information received by the intent object control system 140, and the routine 200 may return to block 204 to receive additional information in order to determine whether an intent is associated with the identified condition, or a condition is associated with the identified intent.

At block 210, the intent object generator 142 generates an intent object based on the information received by the intent object control system 140. The intent object may be a structured data object, where the structure is defined by a schema used by the intent object control system 140 or a third party system 120 that will execute an action when a condition of the intent object is satisfied. The intent object may include various fields to store different types of information for the intent object. For example, an intent object may include a unique intent object identifier, a user 105 associated with the intent, a condition type, a condition value, an indication of a source from which information used to determine whether a condition is satisfied will be received, evaluation logic, a time during which the intent object is valid, a resolution parameter, or additional metadata used to evaluate a condition or execute an action when the condition is satisfied.

A condition type may include indicating that the condition is based on an event outcome, a time that should be reached without an event occurring, a threshold value or price, a location, an environmental condition (e.g., weather, wind speed, earthquake, fire, etc.), a time, an agreement between two or more parties, availability of a computing system, unavailability of a computing system, or any other type of condition that may result in an action being performed associated with a user's intent. A condition value may be a numerical value, a name, text, a sound, or any other value type that may be associated with a condition type that is used to indicate when a condition is satisfied. Evaluation logic may define a mathematical equation or expression, a value comparison, a threshold, or other logic used to determine whether a condition has been satisfied. The evaluation logic may be provided, for example, in a computer code language (e.g., C++, Python, JavaScript, etc.), as a mathematical equation, in pseudocode, in natural language, or as an ordered set of steps to be performed. A resolution requirement describes a validation level at which the intent execution monitor 144 may determine that the condition is satisfied. For example, the resolution requirement may indicate that the intent execution monitor 144 may automatically determine a condition is satisfied when any information indicating satisfaction of the condition is received, may require the intent execution monitor 144 to receive confirmation from at least one user 105, may require the intent execution monitor 144 to confirm received information from a first source using a second source, or may otherwise define how the intent execution monitor 144 is to determine that information used to determine whether a condition is satisfied is valid before executing an action.

Where user confirmation of a generated intent object is requested by the intent object generator 142, the intent object generator 142 may present at least a portion of the generated intent object to the user 105 (e.g., via a display of the user device 110) and request confirmation from the user 105. The user 105 may provide confirmation or acceptance of the generated intent object. The user 105 may provide a modification to be applied to the generated intent object. For example, a generated intent object may include an action of causing the user 105 to transfer 10 dollars to a second user 105. The intent object generator 142 in this example presents at least the action to the user 105 via the user device 110, and the user 105 may then modify the dollar amount and provide the modification to the intent object generator 142. The intent object generator 142 then updates the generated intent object with the user modification to the action.

The unique intent object identifier may be generated based on various types of information available to the intent object generator 142 when the intent object is generated. For example, the intent object generator 142 may hash one or more of an identifier for the user 105, an identifier for the user device 110, an identifier for a third party system 120, a time at which information used to generate the intent object was generated or received, a time at which the intent object is generated by the intent object control system 140, a randomized string, or any other information available to the intent object control system 140 when generating the intent object. An example intent object for storing a bet between two users about who will land a golf ball closest to the 7^{th} hole of a golf course between 10:12 AM on Apr. 1, 2026, and 11:30 AM on Apr. 1, 2026, where the winner receives 10 dollars follows:
{
id: 123nkmldsoj409
subject: “golf”
condition type: “closest_to_pin_distance”
evaluation_logic: comparison(pin_distance_user1, pin_distance_user2)
information_source: “peer_confirmation”
additional_metadata {
   user1: John Smith
   user2: flk1253l
   golf_hole: 7
   }
valid_time {
   start: 2026-04-01:10-12-00
   end: 2026-04-01:11-30-00
   }
originating_user: John Smith
action: pay(10, user(closest_to_pin_distance))
}

While an intent object has been described as being associated with a user for simplicity above, one intent object may be associated with two or more users. For example, where two users enter into a bet, as above, the intent object may be associated with both users, and may include information for the condition and an action associated with each user based on which user is correct in the bet. Further, where an intent object is applicable to multiple third party systems 120, some or all of those third party systems 120 may communicate with the intent object control system 140 to obtain a copy of the intent object, or to interact with (e.g., modify, evaluate, etc.) the intent object stored by the intent object control system 140 so that a single intent object maintains a shared state between third party systems 120.

Intent objects generated by the intent object generator 142 may be associated with a governance policy. The governance policy may indicate whether fields in the intent object are editable; indicate an identity of a user that may create, confirm, void, or otherwise interact with a generated intent object; indicate an access control level (e.g., read-only, write-only, whether a third party system 120 may access the intent object, etc.); describe a dispute protocol for resolving disputes related to the intent object; or provide an expiration rule indicating when the intent object is no longer valid. Further, an intent object may have a lifecycle state. The lifecycle state may indicate the intent object is a draft object (e.g., not yet valid), proposed (e.g., to be provided to a user for confirmation), confirmed as active, triggered (e.g., that at least one condition of the intent object is satisfied), resolved or settled (e.g., that the intent object is no longer active because the condition has been satisfied), voided, expired, or disputed.

In some embodiments, an intent object may be associated with one or more action objects that define how a condition being satisfied is to be resolved. The action object may include an action type, one or more entities against which the action will be executed (e.g., a user whose property will be transferred), a description of the effect of the action, an execution mode of the action (e.g., manual or automatic), an indicator for a third party system 120 that will be used to execute the action, or whether the action is to be described in an auditable action log (e.g., a validated log including information about an action's execution that may be securely stored for later reference and validation). In some embodiments, an intent object may be generated that has no associated action, and may not include a condition, and a condition or action object may be associated with, or added to, the intent object at a later time.

At block 212, the intent object generator 142 stores the generated intent object in the intent object data store(s) 130 for later use. The intent object may be stored in the intent object data store(s) 130 for evaluation by the intent execution monitor 144, as described in further detail with respect to routine 300 of FIG. 3 below.

FIG. 3 illustrates an example routine 300 for executing an action based on satisfying an execution condition of an intent object. The routine 300 begins at block 302, for example in response to a time interval for determination of whether an execution condition has occurred being reached. The time interval may be a fixed interval (e.g., 10 seconds, 1 minute, 10 minutes, one hour, etc.), or a dynamic interval. Where the time interval is a dynamic interval, the time may be determined based on an importance of an intent object, an update rate for an information type or source associated with execution of a condition (e.g., a weather service that updates every five minutes may cause the intent object control system 140 to use a five minute interval for executing the routine 300 for intent objects associated with the weather), a user 105 requesting determination of whether an execution condition has occurred (e.g., via a request received by the intent object control system 140 from the user device 110), or based on any other information available to the intent object control system 140. The routine 300 may be initiated based on a request to access a stored intent object from a user device 110 or third party system 120. For example, one or more third party systems 120 may request to determine whether an intent object indicates an action should be executed by the third party system 120. Advantageously, by maintaining the intent object separately from each third party system 120 in this example, the intent object may not be consumed by the third party system 120 and the intent object control system 140 may update the intent object while allowing a second third party system 120 or a user device 110 to continue using the intent object when determining whether to execute an action.

The intent object control system 140 may use the same time interval for all stored intent objects. The intent object control system 140 may use a different time interval for at least some stored intent objects (e.g., based on an importance of the executed action associated with the intent object, an information type associated with determining whether the execution condition has occurred, the execution condition, etc.). For example, the intent object control system 140 may use a first time interval for all intent objects having an execution condition of a first type, and a second time interval for all intent objects having an execution condition of a second type. The intent object control system 140 may associate a time interval with a user, and execute the routine 300 at that time interval for intent objects associated with the user. In some embodiments, the routine 300 operates continuously to monitor for a condition associated with execution of a stored intent, and continuously receives updated information.

At block 304, the intent execution monitor 144 receives condition information used to determine whether an execution condition has occurred. The condition information may be received from a third party system 120, user device 110, or determined internally by the intent object data store(s) 130 (e.g., based on a clock of the intent object data store(s) 130). The condition information may be associated with a condition of an intent object. The condition information may indicate a change in a status, value, or other information associated with the condition.

At block 306, the intent execution monitor 144 accesses a stored intent object. The intent execution monitor 144 may access the stored intent object based on the type of condition information, the source of the condition information, or a value in the condition information that is associated with the stored intent object. The intent execution monitor 144 may access a stored intent object at regular or varying time intervals. For example, the intent execution monitor 144 may access the stored intent object every five minutes to evaluate the intent object based on any received information. In another example, the intent execution monitor 144 may access the stored intent object as information is received from an information source (e.g., a third party system 120). Such information may be received at different times (e.g., as the information is generated by the third party system 120).

Access to a stored intent object may be secured based on an access control level (e.g., as described in a governance policy associated with the stored intent object). The access control level may allow or deny access to a stored intent object based on an access permission associated with a user 105 or third party system 120 requesting access to the stored intent object. Different access permissions for different third party systems 120, users 105, or user devices 110, may provide permission to access intent objects stored with different access control levels. For example, a first access permission associated with a first third party system 120 may allow access to intent objects stored in the intent object data store(s) 130 that are associated with a first access level but not intent objects associated with a second access level, and a second access permission associated with a second third party system 120 may allow access to intent objects stored in the intent object data store(s) 130 associated with the first access level and the second access level. In some embodiments, access permissions may be used by the intent object data store(s) 130 or intent object control system 140 to control access to particular fields or values in the intent object. For example, a first access permission may provide access to a first set of conditions in an intent object, and a second access permission may provide access to a second set of conditions. The first and second sets of conditions in this example may at least partly overlap.

At block 308, the intent execution monitor 144 compares the condition information to the intent object's execution condition. The comparison may be based on the evaluation logic of the stored intent object. Where the evaluation logic defines an equation, the comparison may include applying the received condition information to the equation to generate a result.

At decision block 310, the intent execution monitor 144 determines whether the execution condition associated with the intent object has been satisfied. As discussed above, determining the execution condition has been satisfied may be based at least in part on executing evaluation logic of the stored intent object, or based on comparing received information to a value in the stored intent object. When the intent execution monitor 144 determines the execution condition is satisfied, the routine 300 moves to block 312 and continues. When the intent execution monitor 144 determines the execution condition is not satisfied, the routine 300 may return to block 304 to receive additional condition information.

At block 312, the intent execution monitor 144 determines what action is to be executed based on satisfaction of the execution condition. The intent execution monitor 144 may determine the action based on the stored intent object. In some embodiments, a type of intent object may be associated with an action by the intent object control system 140 and the action may be executed when the condition is satisfied for any intent object of the intent object type. For example, the intent object control system 140 may store intent objects in the intent object data store(s) 130 that are all of a conditional funding type, where a project will be funded when a threshold interest level is reached. Then, in this example, when the intent execution monitor 144 determines the threshold funding level has been reached the intent execution monitor 144 may cause all associated intent objects to be executed.

At block 314, the intent execution monitor 144 causes execution of the action. The intent execution monitor 144 may cause execution of the action automatically. The intent execution monitor 144 may request input from a user or third party system 120 before causing execution of the action. The intent execution monitor 144 may interact with one or more third party systems 120 (e.g., via an API) to cause execution of the action. The intent execution monitor 144 may transmit a message to a user device 110 to instruct a user 105 to execute an action. The intent execution monitor 144 may execute the action based on instructions included in the intent object or an associated action object. The intent execution monitor 144 may execute the action based on instructions received from a user 105 (e.g., via a user device 110) in response to the intent execution monitor 144 alerting the user that a condition of the intent object has been satisfied.

At block 316, the intent execution monitor 144 updates the intent object based on the action execution. Updating the intent object may include the intent execution monitor 144 updating a lifecycle state of the intent object. Updating the intent object may result in the intent object being no longer valid (e.g., for an intent object that will be executed once). Updating the intent object may include updating a field indicating a number of times an action in the intent object has been executed. Updating the intent object may include updating an action of the intent object based on the previously-executed action.

At block 318, the intent execution monitor 144 stores the updated intent object. The intent execution monitor 144 may store the updated intent object in the intent object data store(s) 130 for later evaluation. The intent execution monitor 144 may store the updated intent object in the intent object data store(s) 130 in a format to allow for later auditing and verification of the execution of the action of the intent object.

### Execution Environment

FIG. 4 illustrates various components of an example computing device 400 configured to implement various functionality described herein.

In some embodiments, the computing device 400 may be implemented using any of a variety of suitable computing devices, such as server computing devices, desktop computing devices, personal computing devices, mobile computing devices, mainframe computing devices, midrange computing devices, host computing devices, or any suitable combination thereof.

In some embodiments, the features and services provided by the computing device 400 may be implemented as web services consumable via one or more communication networks. In further embodiments, the computing device 400 is provided by one or more virtual machines implemented in a hosted computing environment. The hosted computing environment may include one or more rapidly provisioned and released computing resources, such as computing devices, networking devices, and/or storage devices. A hosted computing environment may also be referred to as a “cloud” computing environment

In some embodiments, as shown, a computing device 400 may include: one or more computer processors 402, such as physical central processing units (“CPUs”); one or more network interfaces 404, such as a network interface cards (“NICs”); one or more computer readable medium drives 406, such as a high density disk (“HDDs”), solid state drives (“SSDs”), flash drives, and/or other persistent non-transitory computer readable memory; one or more input/output device interfaces 408; and one or more computer-readable memories 410, such as random access memory (“RAM”) and/or other volatile non-transitory computer readable memory.

The computer-readable memory 410 may include computer program instructions that one or more computer processors 402 execute and/or data that the one or more computer processors 402 use in order to implement one or more embodiments. For example, the computer-readable memory 410 can store an operating system 412 to provide general administration of the computing device 400. As another example, the computer readable memory 410 can store structured object generator 414 for generating a structured object representing an intent. The structured object generator 414 can generate any intent objects disclosed herein. The structure object generator 414 can perform any suitable features of the routine 200 of FIG. 2 for generating an intent object. As another example, the computer-readable memory 410 can store a condition information monitor 416 for receiving and parsing condition information. The condition information monitor 416 can preform any suitable features disclosed herein related to detecting if conditions are satisfied. The condition information monitor 416 can perform any suitable features of the routine 300 of FIG. 3 to detect if a condition is satisfied.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A computer-implemented method comprising:
receiving information associated with a user from a user device, wherein the information comprises an intent and a condition that when satisfied will cause execution of an action;
identifying, from the information, the intent;
generating a first-class intent object comprising the intent, the condition, and the action; and
storing the first-class intent object in computer-readable memory,
wherein the computer-implemented method is performed by a computer system.

2. The computer-implemented method of claim 1, wherein storing the first-class intent object causes the first-class intent object to become available to at least one third party.

3. The computer-implemented method of claim 1, wherein identifying the intent comprises:
parsing the information to isolate a portion of the information; and
analyzing the portion of the information to determine the intent.

4. The computer-implemented method of claim 1, further comprising:
receiving condition information;
comparing the condition information to the condition to determine whether the condition is satisfied; and
based on determining that the condition is satisfied, causing execution of the action.

5. The computer-implemented method of claim 4, wherein causing execution of the action comprises:
transmitting a request to a third party system to cause the third party system to execute the action.

6. The computer-implemented method of claim 4, wherein causing execution of the action comprises:
transmitting a notification to the user device indicating the condition is satisfied.

7. The computer-implemented method of claim 4, wherein causing execution of the action comprises:
transmitting an instruction to the user device to cause the user device to execute the action.

8. The computer-implemented method of claim 4, wherein the first-class intent object comprises evaluation logic, and wherein comparing the condition information to the condition comprises executing the evaluation logic.

9. The computer-implemented method of claim 4, wherein the first-class intent object comprises a lifecycle state, and wherein the computer-implemented method further comprises:
updating the lifecycle state to generate an updated first-class intent object; and
storing the updated first-class intent object.

10. The computer-implemented method of claim 1, wherein the information comprises text information.

11. The computer-implemented method of claim 1, wherein identifying the intent comprises applying the information as input to a machine learning model trained to generate intent information to cause the machine learning model to generate the intent.

12. A computer-implemented method comprising:
receiving information associated with a user from a user device, wherein the information comprises an intent and a condition that when satisfied will cause execution of an action;
identifying, from the information, the intent;
generating an intent object comprising the intent, the condition, and the action, wherein the condition comprises evaluation logic defining how a computing system is to determine whether the condition is satisfied, wherein the action comprises an indication of an action object associated with the intent object, and wherein the action object comprises execution logic for executing the action; and
storing the intent object in a data store, wherein the stored intent object is available to two or more third party computing systems based on an access permission associated with the intent object,
wherein the computer-implemented method is performed by a computer system.

13. The computer-implemented method of claim 12, further comprising:
receiving condition information comprising an indication of a change in status associated with the condition,
executing the evaluation logic based at least in part on the condition information to determine whether the condition has been satisfied;
based on determining the condition has been satisfied, accessing the action object to identify the execution logic for executing the action; and
executing the action based on the identified execution logic.

14. The computer-implemented method of claim 13, further comprising:
updating, based on executing the action, the intent object to generate an updated intent object; and
causing the updated intent object to replace the stored intent object.

15. The computer-implemented method of claim 14, wherein the action is associated with a first service provider, wherein the first service provider is associated with a first third party computing system of the two or more third party computing systems, and wherein the computer-implemented method further comprises:
following the updated intent object replacing the stored intent object, receiving second condition information;
executing the evaluation logic of the updated intent object based at least in part on the second condition information to determine whether a second condition associated with a second action executable by a second service provider has been satisfied, wherein the second service provider is associated with a second third party computing system of the two or more third party computing systems different from the first third party computing system; and
based on the second condition being satisfied, instructing the second service provider to execute the second action.

16. The computer-implemented method of claim 12, wherein identifying the intent comprises applying the information as input to a machine learning model trained to generate intent information to cause the machine learning model to generate the intent.

17. The computer-implemented method of claim 12, wherein the intent object comprises a plurality of conditions associated with a plurality of actions, wherein a first portion of the plurality of actions is associated with a first service provider, and wherein a second portion of the plurality of actions is associated with a second service provider different from the first service provider.

18. The computer-implemented method of claim 12, wherein the evaluation logic comprises at least one of: an equation, or a natural language description of an evaluation process.

19. Non-transitory computer-readable storage comprising instructions stored thereon that, when executed by a computing system, cause the computer-implemented method of claim 12 to be performed.

20. A computer system comprising:
computer-readable storage storing instructions; and
one or more processors configured to execute the instructions to at least:
receive information associated with a user from a user device, wherein the information comprises an intent and a condition that when satisfied will cause execution of an action;
identify, from the information, the intent;
generate an intent object comprising the intent, the condition, and the action, wherein the condition comprises evaluation logic defining how a computing system is to determine whether the condition is satisfied, wherein the action comprises an indication of an action object associated with the intent object, and wherein the action object comprises execution logic for executing the action; and
store the intent object in a data store, wherein the stored intent object is available to two or more third party computing systems based on an access permission associated with the intent object.
